(19) United States
(12) Patent Application Publication
(10) Pub. No.: US 2022/0253480 A1
(43) Pub. Date: Aug. 11, 2022

(54) METHOD AND DEVICE FOR PROVIDING FUNCTION TO REVIEW VISUAL CONTENTS FOR VISUAL CONTENTS PRODUCTION MANAGEMENT

(71) Applicant: BRIGHTN, Inc., Seoul (KR)

(72) Inventor: Jae Hun JEONG, Seoul (KR)

(73) Assignee: BRIGHTN, Inc., Seoul (KR)

(21) Appl. No.: 17/540,640

(22) Filed: Dec. 2, 2021

(30) Foreign Application Priority Data
Feb. 9, 2021 (KR) 10-2021-0018569

(51) Int. Cl. G06F 16/74; G06F 3/04842; G06F 3/04845; G06F 3/04817; G06F 40/169; G06F 16/78

(52) U.S. Cl. CPC G06F 16/745; G06F 3/04842; G06F 16/7867; G06F 3/04817; G06F 40/169; G06F 3/04845

(57) ABSTRACT

A method for providing a function to review visual contents by a server is provided. The method includes (a) providing a visual content upload area to a first terminal and receiving an upload request including identification information of previously produced visual content from the first terminal; (b) receiving a click-input for the visual content of the first terminal or a second terminal invited by the first terminal and providing a review interface to the first terminal or the second terminal; and (c) collecting comment information input by the first terminal or the second terminal through the review interface and storing the comment information by matching with identification information of the visual content, in which the review interface includes a visual content display area, an annotation area and a comment area including a function of visually displaying a portion to be reviewed and evaluated in the visual content display area.

### CROSS-REFERENCE TO RELATED APPLICATIONS

The present application claims priority under 35 U.S.C 119(a) to Korean Patent Application No. 10-2021-0018569, filed on Feb. 9, 2021, which is incorporated herein by reference in its entirety.

### BACKGROUND

### 1. Technical Field

The present disclosure relates to a method and a device for providing a function to review visual contents, and more specifically, relates to a technology for providing a production management platform of produced visual contents and providing a review interface that collects a comment and feedback of a visual content reviewer and displays them visually.

### 2. Related Art

Currently, various visual contents of design, computer graphics (CG), video, and the like are produced and distributed in most industrial fields. In particular, in recent years, as an Internet media sharing platform industry is vitalized, individuals also leverage a lot of visual contents to create revenue, and a market demand thereof is are also rapidly increased.

In general, a task to produce or edit these visual contents is performed in a form in which a client (executive of a corporate or individual) having a specific purpose requests the task from a professional producer (executive of a creator corporate or individual). In addition, in a case of a medium-to-large-scale project, a subcontractor producer is playing the role of an intermediary.

Conventionally, when a project of the production of the visual contents has undertaken, a separate wired or wireless communication system was used in order to perform feedback between the client and the producer, or transmit updated contents. For example, the client and the producer communicate with each other via an e-mail, a phone, a letter, a message, or the like, and share a file. That is, the visual content management and the communication system were dispersed and processed.

Accordingly, from the producer's point of view, excessive production time and effort were often required as the task was extended or fully reviewed due to the client's overturn of decision and delayed feedback. In addition, in a case where the project is prolonged, there is a possibility that various data generated during the task process is omitted. As a result, there was a problem of a decrease in productivity and profitability.

From the client's point of view, since it is necessary to invest extra time and resources to give feedback on the contents provided by the producer, there were difficulties such as a decrease in the efficiency of the project management. In addition, in a case where the project is prolonged, there was a problem that it is difficult to grasp whether the scheduled feedbacks have been delivered and reflected.

On the other hand, in a case of collaborating with the subcontractor producer, separate manpower, time, and resources were required in the process of collecting and transmitting opinions of each side thereof.

Therefore, as the number of personnel involved and the scale of the project increase, amounts of feedback and intermediate data that occur increase and are complicated, so that a system capable of integrating, collecting, and managing them is required.

### SUMMARY

An object of a system for providing a function to review visual contents according to an embodiment of the present disclosure is to provide a user interface capable of collecting and sharing opinions and feedback of project members on visual contents produced during a project process.

In addition, another object of the present disclosure is to ensure objectivity, perform a review task more quickly, and increase the productivity of the visual contents by simultaneously displaying a comment input by a project member and visual contents corresponding thereto on one screen.

A method for providing a function to review visual contents by a server according to an embodiment of the present disclosure, the method including: (a) providing a visual content upload area to a first terminal and receiving an upload request including identification information of previously produced visual content from the first terminal; (b) receiving a click-input for the visual content of the first terminal or a second terminal invited by the first terminal and providing a review interface to the first terminal or the second terminal; and (c) collecting comment information input by the first terminal or the second terminal through the review interface and storing the comment information by matching with the identification information of the visual content. The first terminal and the second terminal respectively mean a visual content producer terminal and a reviewer terminal. The visual content includes a still image or a moving image, and the moving image is configured of a set of a plurality of still frames formed in a preset order. The review interface includes a visual content display area, an annotation area and a comment area including a function of visually displaying a portion to be reviewed and evaluated in the visual content display area.

In the step (b) according to an embodiment of the present disclosure, when the visual content is a still image, the visual content display area provides a function of enlarging or reducing the still image, and when the visual content is a moving image, the visual content display area sequentially displays each still frame based on a playback mode selected and input by the first terminal or the second terminal. The playback mode include at least one of for hour-minute-second, for frame, and for hour-minute-second vs frame per second.

In the method for providing a function to review visual contents according to an embodiment of the present disclosure, the comment area provides a function of inputting comment information related to the visual content, and the comment information includes text information and voice information. In a state where a specific still image or still frame is displayed in the visual content display area, the comment information input by the second terminal is displayed in the comment area, and is stored by matching with the still image or the still frame.

The step (b) according to an embodiment of the present disclosure includes displaying a still image or a still frame matched with the click-input comment information in the visual content display area when the first terminal performs a click-input on one of the comment information displayed in the comment area.

In the method for providing a function to review visual contents according to an embodiment of the present disclosure, when the visual content is a moving image, a predetermined comment icon corresponding to the still frame matched with the comment information is generated and matches with the still frame. The comment icon is displayed in a portion corresponding to the still frame matched with the comment icon in a still frame selection function area included in the visual content display area. When the first terminal or the second terminal performs a click-input on the comment icon, the still frame is displayed in the visual content display area and comment information matched with the still frame is displayed in the comment area.

In the step (b) according to an embodiment of the present disclosure, the annotation area provides a drawing input function and a comment input function. The step (b) includes generating a drawing image based on the drawing input and displaying the drawing image by overlapping in a still image or a still frame displayed in the visual content display area when the second terminal selects and inputs a drawing tool and color, and performs the drawing input function; and matching and storing the drawing image and a predetermined identification icon.

In the method for providing a function to review visual contents according to an embodiment of the present disclosure, the comment input function provided by the annotation area includes a text and voice input function. When the second terminal inputs comment information related to the drawing image through the comment input function, the input comment information is displayed in the comment area in the review interface and matched with the still image or the still frame, and stored. The identification icon matched with the drawing image is further displayed in an area in which the comment information is displayed.

In the method for providing a function to review visual contents according to an embodiment of the present disclosure, when the first terminal performs a click-input on the comment information related to the drawing image, a still image or a still frame matched with the comment information, and a drawing image matched with the identification icon are displayed in the visual content display area. A preset image processing process is performed and displayed so that the drawing image is highlighted.

In the method for providing a function to review visual contents according to an embodiment of the present disclosure, in the step (c), a visual content which is initially uploaded is set as a first main version and stored. When an additional visual content is uploaded to the upload area, the additional visual content is set and stored as a next main version having a precedence relationship based on the version check input of the first terminal or the second terminal, or a subversion having a parallel relationship in the same main version. The step (c) includes managing the comment area in main version unit by matching the collected comment information with identification information of the visual content corresponding to the main version having the parallel relationship with the subversion, and storing the collected comment information, when the comment information is collected in a state where the visual content corresponding to the subversion is displayed in the visual content display area.

In the method for providing a function to review visual contents according to an embodiment of the present disclosure, after the step (b), in a state where a review interface for the first visual content, which is one of the all versions of the visual content, is provided to the first terminal or the second terminal, further including: receiving an input for a comparison menu in the review interface from the first terminal or the second terminal, and providing a version tree area in which the all versions of the visual content is displayed; receiving a selection input for a second visual content from the first terminal or the second terminal through the version tree area; and dividing the visual content display area in the review interface into two and displaying the first visual content in one area and the second visual content in the other area.

In the method for providing a function to review visual contents according to an embodiment of the present disclosure, when the first and second visual contents are moving images, the visual content display area provides a function of simultaneously playing back and pausing the first and second visual contents. When the first and second visual contents are still images, the first and second visual contents are displayed overlapping each other, and a dividing line is formed in the middle of the visual content display area, the first visual content is displayed as upper in one area based on the dividing line, and the second visual content is displayed as upper in the other area based on the dividing line. Wherein an area, in which one of the first and second visual contents is displayed as upper, is expanded, and the other is displayed as lower corresponding to the expanded area based on a movement input of the dividing line.

A device for providing a function to review visual contents according to an embodiment of the present disclosure, the device including: a memory in which a program for performing a method for providing a function to review visual contents is stored; and a processor for executing the program. The processor, by executing the program, provides a visual content upload area to a first terminal and receives an upload request including identification information of previously produced visual content from the first terminal; receives a click-input for the visual content of the first terminal or a second terminal invited by the first terminal and provides a review interface to the first terminal or the second terminal; and collects comment information input by the first terminal or the second terminal through the review interface and stores the comment information by matching with the identification information of the visual content. The first terminal and the second terminal respectively mean a visual content producer terminal and a reviewer terminal. The visual content includes a still image or a moving image, and the moving image is configured of a set of a plurality of still frames formed in a preset order. The review interface includes a visual content display area, an annotation area and a comment area including a function of visually displaying a portion to be reviewed and evaluated in the visual content display area.

The method and the device for providing a platform to manage produced visual contents according to an embodiment of the present disclosure provide an integrated function of the visual content management and communication function to support efficient transmission of feedback and sharing of a project progress status between the client, the producer, and other project-related parties.

In addition, by making it possible to visually grasp the feedback information that has been transmitted verbally with respect to the produced visual content, objectivity may be ensured and the update of the visual content may be induced more quickly and accurately.

On the other hand, according to an embodiment of the present disclosure, even in a case of a large-scale project or a long-term project, various types of data generated in the process may be systematically collected and managed, and a function of effectively identifying necessary data from among such a large amount of data provides.

Accordingly, as the efficiency and predictability of the project production management are improved, the productivity of visual content may be increased. In addition, by integrating the communication of respective subjects related to the project without using a separate system, transparency of the task may be ensured and the problem of unnecessary time, manpower and resource consumption may be solved.

### BRIEF DESCRIPTION OF THE DRAWINGS

Various embodiments of the present disclosure will become more apparent in view of the attached drawings and accompanying detailed description, in which:

FIG. 1 is a structural diagram of a system for providing a platform to manage produced visual contents according to an embodiment of the present disclosure;

FIG. 2 is a flowchart of a method for providing a platform to manage produced visual contents according to an embodiment of the present disclosure;

FIG. 3 is an exemplary view of a project interface according to an embodiment of the present disclosure;

FIG. 4 is an exemplary view of a main interface according to an embodiment of the present disclosure;

FIG. 5 is an exemplary view of an upload area of a review menu according to an embodiment of the present disclosure;

FIG. 6 is an exemplary view of a version tree area of a version control menu according to an embodiment of the present disclosure;

FIG. 7 is an exemplary view of a review interface according to an embodiment of the present disclosure;

FIG. 8 is an exemplary view of a visual content display area and an annotation area in the review interface according to an embodiment of the present disclosure;

FIG. 9 is an exemplary view of a comment area in the review interface according to an embodiment of the present disclosure;

FIG. 10 is an exemplary view for explaining a comparison function in the review interface according to an embodiment of the present disclosure;

FIG. 11 is an exemplary view for explaining a shared link function according to an embodiment of the present disclosure;

FIG. 12 is an exemplary view for explaining a chat function according to an embodiment of the present disclosure; and

FIG. 13 is an exemplary view of an upload area of reference data according to an embodiment of the present disclosure.

### DETAILED DESCRIPTION

Hereinafter, with reference to the accompanying drawings, embodiments of the present disclosure will be described in detail so that those of ordinary skill in the art may easily carry out the present disclosure. However, the present disclosure may be implemented in many different forms and is not limited to the embodiments described herein. In addition, a part not related to the description in order to clearly describe the present disclosure in the drawing was omitted, and like reference numerals indicate like elements throughout the specification.

In the specification, when expressing a portion is “connected” to another portion, it includes not only a case of “directly connected” but also a case of “electrically connected” with another element interposed therebetween. In addition, when a portion “includes” a configuration element, which does not exclude other configuration elements and means that it may further include the other configuration elements.

The “terminal” referred to below may be implemented by a computer or a portable terminal that may access to a server or other terminals via a network. Here, the computer may include, for example, a notebook computer equipped with a web browser, a desktop, a laptop, a VR HMD (for example, HTC VIVE, Oculus Rift, GearVR, DayDream, PSVR, or the like), and the like. Here, the VR HMD includes a Stand Alone model (for example, Deepon, PICO, or the like) which is independently implemented from for a PC (for example, HTC VIVE, Oculus Rift, FOVE, Deepon, or the like), for mobile (for example, GearVR, DayDream, Baofeng Mojing, google cardboard, or the like), and for a console (PSVR). The portable terminal includes, for example, various devices equipped with a communication module such as Bluetooth (BLE, Bluetooth Low Energy), NFC, RFID, ultrasonic wave, infrared, WiFi, LiFi, as well as a smart phone, a tablet PC, and a wearable device as a wireless communications device that ensures the portability and mobility. In addition, the “network” means a connection structure capable of exchanging information between respective nodes such as terminals and servers, and includes local area network (LAN), a wide area network (WAN), an Internet (WWW: World Wide Web), wired and wireless data communication network, telephone network, wired and wireless television network, and the like. An example of the wireless data communication network includes 3G, 4G, 5G, 3GPP (3rd Generation Partnership Project), LTE (Long Term Evolution), WIMAX (World Interoperability for Microwave Access), Wi-Fi, Bluetooth communication, infrared communication, ultrasound communication, visible light communication (VLC), LiFi, or the like, but is not limited to this.

Hereinafter, an embodiment of the present disclosure will be described in detail with reference to the accompanying drawings.

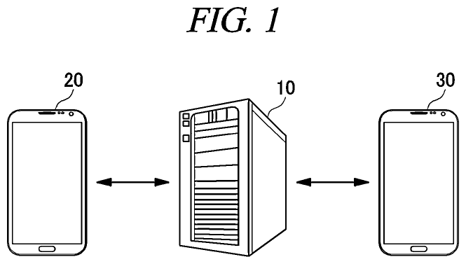

FIG. 1 is a structure diagram of a system for providing a platform to manage produced visual contents according to an embodiment of the present disclosure.

Referring to FIG. 1, the system for providing a platform to manage produced visual contents according to an embodiment of the present disclosure may include a server 10 that is connected to each of terminals to perform overall tasks in a platform, a first terminal 20, and a plurality of second terminals 30.

Here, the server 10 may be defined as a device for providing a platform to manage produced visual contents. In addition, the server 10 may be configured to include a memory in which a program (or application) for performing a method for providing a platform to manage produced visual contents is stored, and a processor executing the program.

The first terminal 1 according to an embodiment of the present disclosure means a terminal of a subject who is an owner of a project for visual content management. For example, the subject may be a visual content producer, a designer, or the like, and in some cases, may be a project manager or a planner. The subject of the first terminal 20 may generate a project, upload a visual content, and invite and manage other members of the project. In addition, the subject may perform overall authority on the project generated by himself/herself via a project interface provided by the server 10, such as deleting the project or storing a record of a closed project.

The second terminal 30 according to an embodiment of the present disclosure means a terminal of a subject requested as a project member. Accordingly, the second terminal 30 may be defined in various ways according to the subject of the first terminal 20 and a situation thereof, and may be configured in plurality. For example, in a case where the visual content producer or the designer generates a project, and invites a member, it may be a terminal of a client who requests the visual content, a project planner, a collaborative designer, a partner designer, or the like. In this case, the second terminal 30 generally performs a review function with respect to the visual content which is uploaded by the first terminal 20 and if necessary, may upload a modified content and invite other project members. That is, when accepting the invitation of the generated project, the second terminal 30 may be provided with a main interface of the project to perform organic collaboration and communication with the first terminal 20.

The first terminal 20 and the second terminal 30 described above may be terminals previously registered in the server 10 that has performed a predetermined membership registration procedure. Alternatively, the system according to an embodiment of the present disclosure may include a third terminal that is not registered in the server 10. For example, in a case where the subjects of the first terminal 20 and the second terminal 30 are respectively the visual content producer and the partner designer, a terminal of the client who requested it may be the third terminal. According to an embodiment, the third terminal may share the visual content transmitted by the terminals 20 and 30 of the project members, and may function only in a preset authority. A detailed description will be given later through an embodiment of the shared link function.

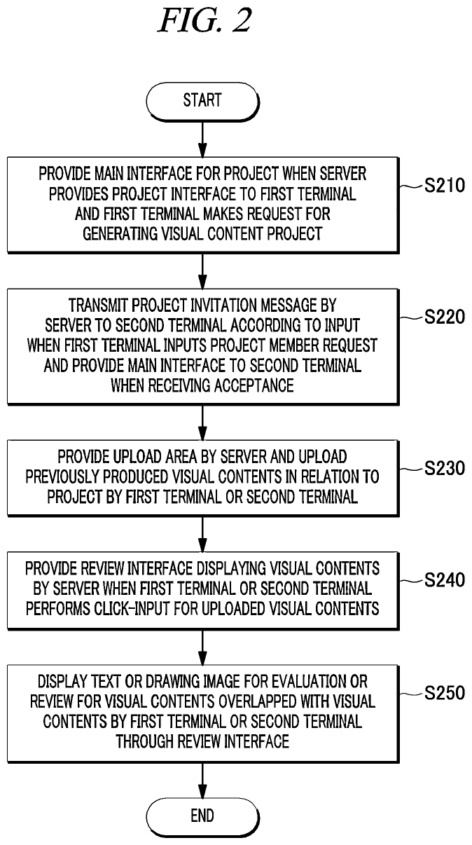

Hereinafter, a method for providing a platform to manage produced visual contents according to an embodiment of the present disclosure will be explained in detail with reference to FIGS. 2 to 13.

FIG. 2 is a flowchart of the method for providing a platform to manage produced visual contents according to an embodiment of the present disclosure.

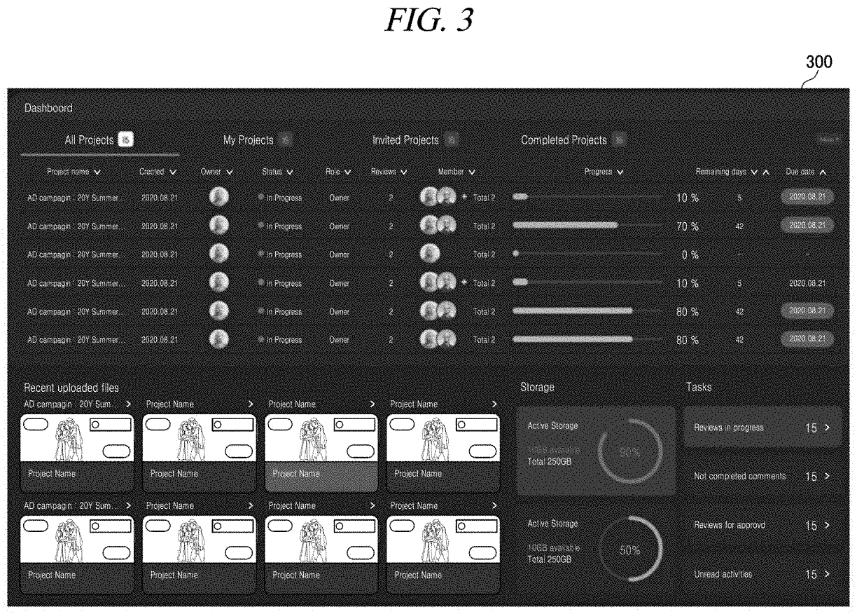

In step S210, the server 10 may provide a project interface 300 that may execute a project generation request for visual content management to the first terminal 20. In a case where there is a request for generating the project, the project interface 300 provides an area for inputting project identification information and the project identification information may include a project name, a project schedule, a project manager name, and summary information on the project. Of course, the first terminal 20 may request generation of a plurality of projects and there may exist a project that has been generated in advance and is in progress. Referring to FIG. 3, the server 10 may be configured and provided with a dashboard area indicating a progress and a task status for each project which is involved by the first terminal 20.

FIG. 3 is an exemplary view of the project interface according to an embodiment of the present disclosure.

Referring to FIG. 3, the dashboard area may provide a function of providing items in which projects related to the first terminal 20 are classified by predetermined characteristics and selectively inputting the items. For example, the items may include items classified as all projects, a project of which a user of the first terminal 20 is the owner, an invited project, and an already completed project. When the first terminal 20 performs a click-input for such an item, the server 10 may display and provide projects corresponding to the items in a list area.

For example, in a case where the first terminal 20 click-inputs the item for the its own project, information displayed in the list area may include status information indicating project in progress or the completion thereof, project progress-degree information, and project member information, in addition to the project identification information received from the first terminal 20. Accordingly, even in a case where the user of the first terminal 20 progresses multiple projects or participates therein at the same time, the user may grasp a status of each project at a glance.

In addition, the dashboard area may provide an additional function for user convenience to the first terminal 20. For example, even in a case where a project is prolonged or various projects are progressed at the same time, for example, recently uploaded visual content information for each project is displayed or a task management function related to each project is provided, it may provide a basis for the user to efficiently carry out the task.

In step S210, the server 10 may generate a project according to a project generation request and provide the main interface 400 for the generated project to the first terminal 20.

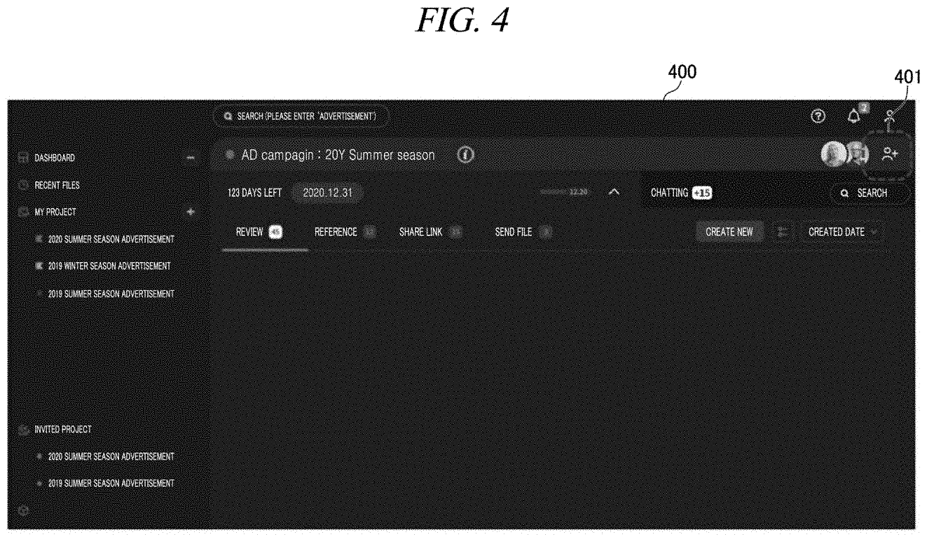

FIG. 4 is an exemplary view of the main interface according to an embodiment of the present disclosure.

Referring to FIG. 4, the main interface 400 may include respective menus that may provide various management functions for the project. Specifically, the main interface 400 may include at least one of a review menu, a reference menu, a shared link transmission menu, a file transmission menu, a project member request (management) menu, a version management menu, and a chat menu, and this configuration does not limit the present disclosure. Specific examples of such menus will be described later.

In step S220, the first terminal 20 may click the project member request menu 401 in the main interface 400 to perform an input for the project member request. In this case, the server 10 may provide an input area for identification information such as number information and e-mail information of the second terminal 30 corresponding to the member to be invited.

As an additional embodiment, the first terminal 20 may perform the authority check function in the second terminal identification information input area. For example, a check item for selecting one of a creator and a reviewer may be configured based on the user of the second terminal 30. Afterwards, the second terminal 30 to which the creator item is checked and invited may be provided with the main interface 400 for the project and perform the review function. On the other hand, the second terminal 30 to which the reviewer item is checked and invited may be provided with the main interface 400 and perform the review function, but an authority to upload a new visual content in the main interface 400 is not granted. That is, by providing separately a predetermined authority to each of the second terminals 30, it is possible to prevent confusion of task by clearly dividing roles within the project.

In step S220, the server 10 may transmit a project invitation message to the second terminal 30 based on the second terminal identification information. Thereafter, in a case of receiving the input of the acceptance of the second terminal 30, the main interface 400 for the project may be provided to the second terminal 30. That is, the invited user of the second terminal 30 may use various functions included in the main interface 400.

As an additional embodiment, in a case where the second terminal 30 is not registered in advance, the server 10 may provide a membership registration interface to the second terminal 30 in advance. This is because, in order for the server 10 to provide the main interface 400, the review interface 700, or the like, and to utilize various functions in each interface, a unique account area must be assigned to each user terminal. In addition, according to an embodiment of the present disclosure, since the server 10 may collect and utilize an activity log of each terminal in the project, that is, traffic information, predetermined terminal information such as IP information must be grasped in advance. Thus, the server 10 may provide the main interface 400 to the second terminal 30 after the second terminal 30 performs a membership registration procedure, and receives and registers an account.

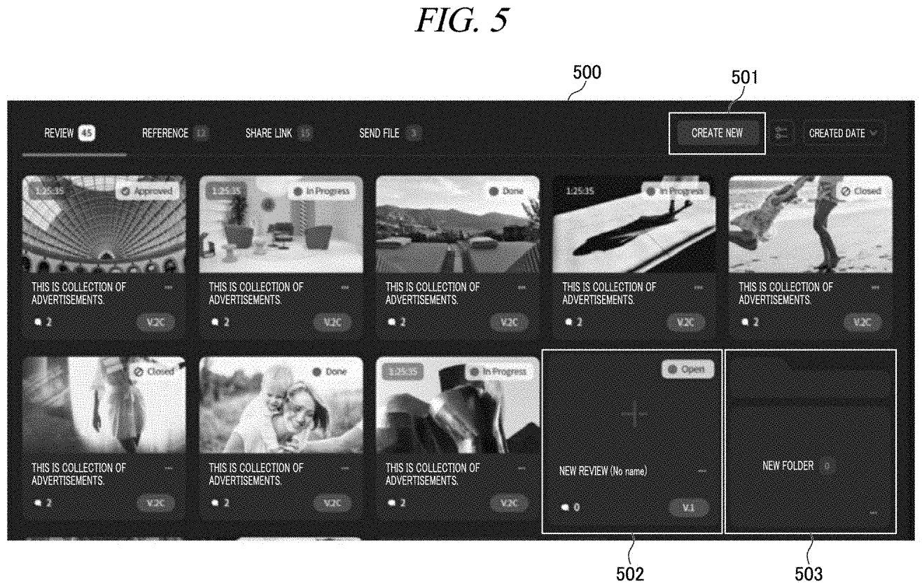

In step S230, in a case where the first terminal 20 or the second terminal 30 click-inputs the review menu in the main interface 400, the server 10 may provide the upload interface 500. Thereafter, the first terminal 20 or the second terminal 30 may upload a previously produced visual content related to the project to a provided upload area 502. An embodiment related thereto will be described with reference to FIG. 5.

FIG. 5 is an exemplary view of the upload area according to the review menu according to an embodiment of the present disclosure.

According to an embodiment of the present disclosure, in a case where each of the terminals 20 and 30 to which an upload authority is given clicks an upload request menu 501 in the uploaded interface 500, the upload area 502 capable of uploading a new visual content may be provided. Thereafter, the first terminal 20 or the second terminal 30 may upload the visual content related to the project to the provided upload area 502 and input visual content identification information such as a title. The server 10 may match the uploaded visual content with a database corresponding to the upload area 502 and store the visual content.

As an additional embodiment, each terminal may upload a plurality of visual contents at once. In this case, the server 10 may generate each upload area 502 according to information on the number of visual contents requested to be uploaded. For example, in a case where two contents of ‘advertisement video a’ and ‘advertisement video b’ are uploaded at the same time, two upload areas corresponding to respective contents are generated at the same time and to be matched, respectively.

Also, each terminal may perform a folder function of the upload interface 500. For example, in a case where the first terminal 20 requests the folder function, the server 10 may generate the folder area 503 to be provided, and the first terminal may click the folder area 503 to be provided with a new upload area 502 in the folder area. Alternatively, the uploaded visual content may be included in the folder area 503 by being dragged, moved, and input to a previously generated upload area. In addition, a new subfolder area may be configured in the folder area 503. In this way, it is possible to efficiently carry out projects involving multiple visual contents by managing closely related visual contents in one folder.

On the other hand, in view of the object of the present disclosure, the visual content may be produced in various versions. For example, in a case where an apparel company X commissions a producer Y to produce a product advertisement video, for example, the producer Y may produce various drafts for the advertisement video. In addition, for a first draft, feedback may be provided from the apparel company X through the review function according to the present disclosure, various corrected versions of the first draft may be produced, and the content may be continuously updated through repeated reviews until a completed version is provided. That is, a plurality of main versions may be produced for one content according to the updating, and a plurality of subversions may be produced for each main version like the various draft or corrected versions exemplified above.

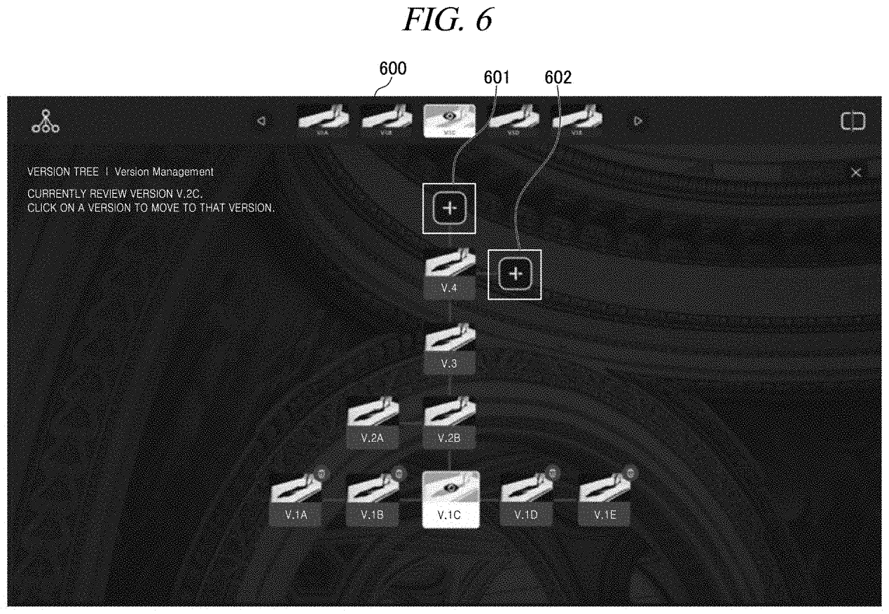

According to an embodiment of the present disclosure, the first terminal 20 or the second terminal 30 may perform a function of comprehensively managing various versions as described above, contents related thereto will be described with reference to FIG. 6.

FIG. 6 is an exemplary view of a version tree area of a version control menu according to an embodiment of the present disclosure.

First, according to an embodiment of the present disclosure, the server 10 may set and store a first visual content uploaded to one upload area 502 as the first main version. For example, when the first visual content is uploaded to the upload area 502, the number of ‘V1’ may be displayed in the upload area.

Thereafter, the first terminal 20 or the second terminal 30 may perform a version check input while uploading subsequent visual content to the upload area 502. The version check input may mean a selection input for one of a next-main version having a precedence relationship and a subversion having a parallel relationship with the first main version. As illustrated in FIG. 6, for example, a main version check item 601 configured on an upper end of the specific visual content and a subversion check item 602 configured on a right side thereof may be mentioned.

The server 10 may set and store a version of the subsequent visual content based on the version check input. For example, in a case where a first draft for the ‘advertisement video a’ is first uploaded from the first terminal 20 and is set and stored as the first main version, and then a second draft is produced and is uploaded as the subsequent visual content, the first terminal 20 may perform the check input with the subversion and the server 10 may set the subversion as the first subversion for the first main version. In addition, the server 10 may additionally match a second draft with the database corresponding to the upload area 502 to be stored, and display the number of ‘V.1A’ to the upload area 502 according to the second draft which is recently uploaded. On the other hand, in a case where a first corrected version, in which a feedback is reflected after the first main version, is produced, the first terminal 20 may perform the check input with the main version and the server 10 may set the main version as a second main version. In addition, the server 10 may additionally match the first corrected version with the database corresponding to the upload area 502 to be stored, and displays the number of ‘V.2’ to the upload area 502 according to the first corrected version which is recently uploaded.

According to an embodiment of the present disclosure, if the first terminal 20 or the second terminal 30 performs an input for the version management menu in the main interface 400, the server 10 may provide a version tree area 600 that displays all the versions stored in the upload area being performed in the main interface 400 currently. Alternatively, it may be provided even in a case where an input for a comparison menu 750 in a review interface 700, which will be described later, is received.

Referring to FIG. 4, the version tree area 600 may include a vertical axis indicating upper and lower versions configured of main versions and at least one horizontal axis indicating before and after upload times configured of subversions for each main version. For example, moving toward the top of the tree may mean the next main version, and moving from the left to the right may mean the recently uploaded subversion for one main version.

In a case of receiving a selection input for one of the versions displayed in the version tree area 600 from the second terminal 30, the server 10 may provide the review interface 700 for the visual content corresponding to the version. That is, according to an embodiment of the present disclosure, various versions for one visual content may be collected, matched, and stored in one upload area 502. Even during the project members carry out the task for a specific version, the project members may easily browse contents for other versions and perform a review function therefor.

In an additional embodiment, referring to FIG. 5, version information may be displayed in each upload area. As described above, it may be a version that has been recently uploaded, or a version in which a review function is currently being performed or a version that has been recently performed among all versions. In addition, according to the input of the status information in the upload area 502 of the first terminal 20 or the second terminal 30, the status information may be displayed in each upload area. For example, predetermined status information may be displayed indicating ‘in progress’ in a case where a task including the review function of the visual content corresponding to the version information of ‘V.2C’ (meaning the third subversion of the second main version) is in progress, or ‘completed’ in a case of being completed. Of course, the configuration of the state information is not limited to this example.

In this way, the independent upload area 502 is granted by each visual content unit, so that even in a case where a lot of visual contents are handled, it is possible to be systematically managed. Further, during performing the project, even if various visual contents related to one visual version are produced, the management system may be further consolidated through the version tree area 600.

Referring back to FIG. 2, in step S240, in a case where the first terminal 20 or the second terminal 30 performs the click-input on the visual content uploaded to the upload area 502, the server 10 may provide the review interface 700 displaying the visual content. That is, the project members may use the review function for the visual content via their respective terminals. On the other hand, in a case where various versions are uploaded to the upload area 502, the review interface 700 of the content corresponding to the version information currently displayed in the upload area 502 may be provided.

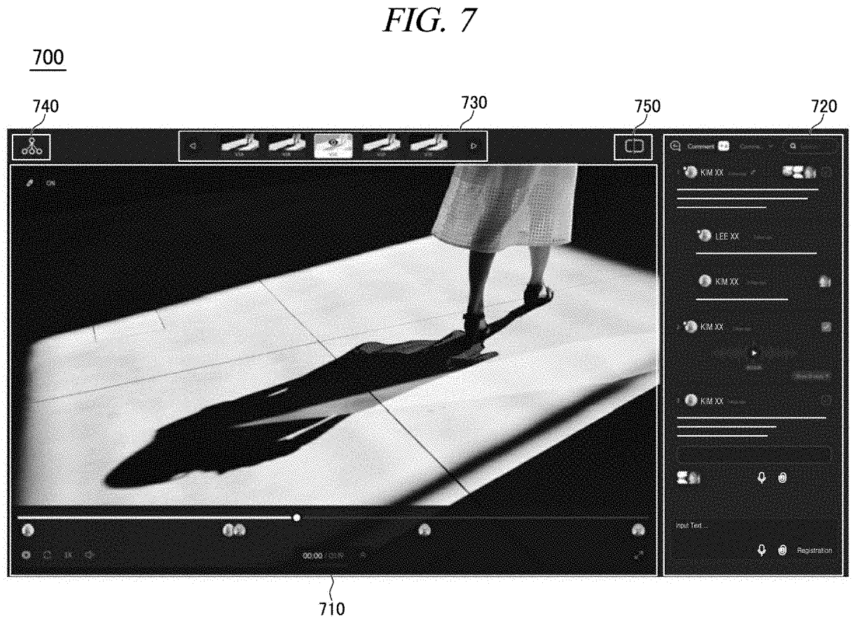

Hereinafter, the review function according to an embodiment of the present disclosure will be described with reference to FIGS. 7 to 10. In the following embodiments, for description clarity, the first terminal 20 and the second terminal 30 are defined as the visual content producer terminal and the reviewer terminal, respectively.

FIG. 7 is an exemplary view of the review interface according to an embodiment of the present disclosure.

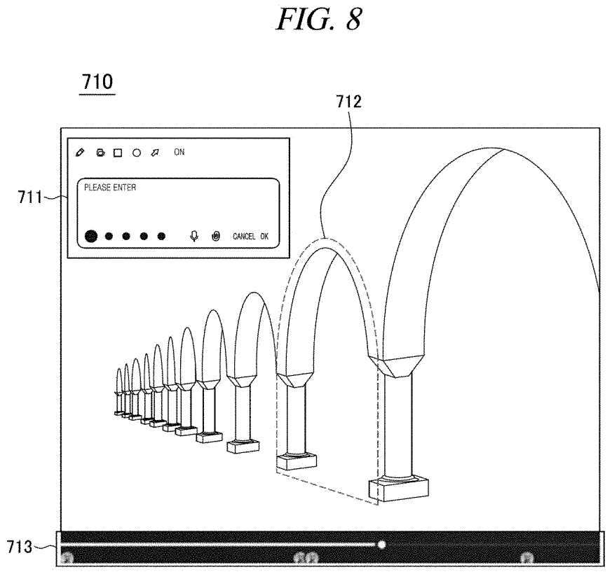

FIG. 8 is an exemplary view of the visual content display area and the annotation area in the review interface according to an embodiment of the present disclosure.

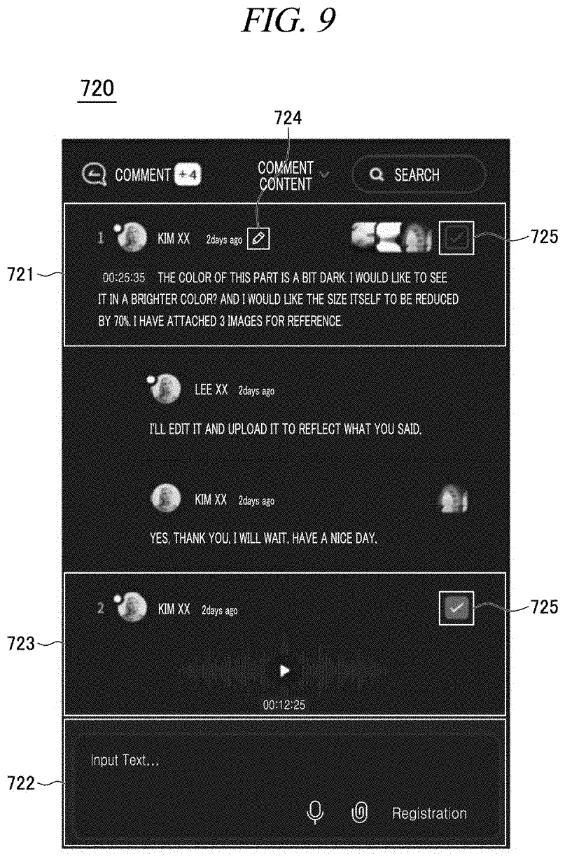

FIG. 9 is an exemplary view of the comment area in the review interface according to an embodiment of the present disclosure.

Referring to FIGS. 7 to 9, the review interface 700 according to an embodiment of the present disclosure may include a visual content display area 710 and a comment area 720.

The visual content display area 710 is an area in which the visual content, for which the producer or the reviewer performs the review task, is displayed. That is, the visual content selected and input for review by the producer terminal or the reviewer terminal among previously uploaded visual contents in the upload interface 500 may be displayed.

Here, the visual content according to an embodiment of the present disclosure may mean any type of file that is transmitted. For example, still images of image files such as png, jpg, tiff, and gif, document files such as word, Korean file, pdf, ppt, and excel, and code files such as java and html may be included. In addition, moving images of holograms, multi-angle three-dimensional shapes, presentation documents such as pptx, and video files such as TS, mp4, avi, and mkv may be included. That is, the moving image may means a set of a plurality of (static) frames in a preset order. Of course, the above examples do not limit the present disclosure.

According to an embodiment of the present disclosure, in a case where the displayed visual content is the still image, the visual content display area 710 may provide a function of enlarging or reducing the still image.

On the other hand, in a case of the moving image, the first terminal 20 or the second terminal 30 may perform a selection input function of the playback mode. The playback mode may include at least one of hour-minute-second (STANDARD), frame (FRAME), and hour-minute-second vs frame per second (TIME CODE). A selection input window may be configured in one area of a lower portion of the displayed moving image. For example, in a case of a general moving image, by selecting the hour-minute-second playback mode, the expression and content of the entire moving image may be grasped, or a still frame corresponding to a temporarily paused time may be intensively examined. Alternatively, in a case of the hologram image, by selecting the frame playback mode, the overall operation and the status change of the hologram may be grasped, or an instantaneous image of the hologram corresponding to each still frame may be intensively examined.

Referring to FIG. 9, a specific example of the comment area 720 of the review interface 700 may be viewed. The reviewer may input the comment information related to the visual content via the comment input window 722. That is, the reviewer may leave feedback (evaluation, opinion, correction request item, or the like) on the displayed object in the visual content display area 710, in an image in which a specific still frame of the still image or the moving image is displayed.

When receiving the comment information, the server 10 may display the comment information in the comment area 720 in real time and match it with the still image or the still frame to be stored. That is, the comment information may be uniquely managed for each image data displayed in the visual content display area 710 when being input. For example, in a state where the visual content is the moving image, reviewer may pause the moving image and input the comment information in a state where a still frame of a specific moment is displayed. In this case, the comment information may match with the still frame and hour-minute-second information corresponding to the still frame may be displayed in the area in which the comment information is displayed.

Thereafter, the producer may access the server 10 via the first terminal 20 to confirm the reviewer's feedback and be provided with the review interface 700 of the visual content, thereby receiving the comment information input by the reviewer. When performing a click input on one of the received comment information, the server 10 displays the still image or the still frame matched with the comment information in the display area 710. As it illustrated above, in a case of the moving image, the still frame corresponding to the hour-minute-second information included in the area, in which the click-input comment information is displayed, may be displayed on a screen of the first terminal 20.

In addition, the comment information may be input through voice as well as text. The comment information input through the voice input is similarly displayed in the comment area 720 and may be matched with the corresponding still image or the still frame. Accordingly, when the producer clicks on it, a voice comment is output from the first terminal 20 and the matched still image or the still frame may be displayed on the screen.

On the other hand, according to an embodiment of the present disclosure, in a case where the visual content is the moving image, when the comment information is input on a specific still frame, a predetermined comment icon may be generated and match with the still frame to be stored. Referring to FIG. 8, such a comment icon may be displayed at a portion corresponding to the matched still frame in the still frame selection function area 713 included in the visual content display area 710. For example, in a case of the moving image, a predetermined playback bar may be configured. In the hour-minute-second section with which each comment information is matched at the lower end portion of the playback bar, respective comment icons corresponding thereto may be disposed. Thereafter, in a case where the producer or the reviewer clicks the displayed comment icon via each terminal, the server 10 may display the still frame matched with the comment icon in the visual content display area 710, and display the comment information matched with the still frame in comment area 720.

As described above, according to an embodiment of the present disclosure, by matching the specific image data with the comment information input in relation thereto and independently managing them, the producer may grasp immediately which part of the visual content the reviewer has mentioned. Therefore, the producer may objectively recognize the relevant part without needing to manually find the relevant part and grasp the need of the reviewer. The reviewer may also solve the anxiety about whether the provided feedback is properly transmitted, or the hassle of having to check it again.

In step S250, each terminal may overlap a predetermined text or drawing image for the evaluation or review via the annotation area 711 in the review interface 700 to be displayed.

Referring to FIG. 8, an example of the annotation area 711 of the present disclosure is illustrated. The annotation area 711 may provide a function of visually providing a portion which is reviewed and evaluated in the visual content display area 710. That is, the drawing input function may be included.

For example, the content production reviewer may select a drawing tool through the second terminal 30. The drawing tool may mean an option capable of inputting by drawing in a preset drawing shape (circle, predetermined polygon, or the like) or an arbitrary shape by cursor tracking. In addition, a color may be selectively input to clearly distinguish it from the visual content. After selecting such an option, if the second terminal 30 performs a drawing input on a portion to be fed back, the server 10 may generate the drawing image 712 based thereon and display the drawing image 712 overlapping the corresponding portion. In general, the reviewers are mostly unfamiliar with image data production or editing tools. Therefore, in the prior art, there was a problem in that it is difficult for the producer to grasp the portion that is the feedback target because it has to be transmitted orally. As described above, through the drawing input function according to an embodiment of the present disclosure, the reviewer may easily express the feedback portion visually, and accordingly, the objectivity of the reviewer's request may be guaranteed from the point of view of the producer.

In addition, referring to FIG. 8, the annotation area 711 may provide a comment input function related to the drawing image 712. Similar to the function of the comment area 720, the text and voice input functions may be included, and accordingly, the input comment information may be displayed in the comment area 720, and match with the displayed still image or still frame in which the drawing image 712 is displayed to be stored.

According to an embodiment of the present disclosure, the server 10 may match the drawing image 712 with a predetermined identification icon 724 while generating the drawing image 712, and store it. Referring to FIG. 9, the matched identification icon 724 may be additionally displayed in an area in which the comment information related to the drawing image 712 is displayed. For example, as illustrated in FIG. 9, it may be a predetermined pen-shaped icon indicating that the drawing input is performed, but is not limited to this. Accordingly, the producer may quickly catch the fact that the reviewer displayed the drawing image 712 while leaving the comment, and this effect may be maximized when many comments are written.

In a case where the producer terminal 20 performs the click-input on the comment information related to the drawing image 712, the server 10 may display the still image or the still frame matched thereto in the visual content display area 710, and overlap the drawing image 712 and display it. According to an embodiment of the present disclosure, the server 10 may perform a preset image processing process on the visual content display area 710 and emphasize the drawing image 712 so that the producer may clearly grasp the drawing image 712. For example, the server 10 may provide the drawing image 712 after a processing process for increasing the saturation or sharpness of the displayed portion or lowering the brightness of other portions. Of course, these examples do not limit the present disclosure.

In an additional embodiment, in a case where one of the project members inputs the comment information through the comment area 720 or the annotation area 711, the server 10 may transmit a predetermined message notifying that new comment information has been registered to the terminals of the other members. For example, it may be provided through other message functions (SMS, message APP, and the like) outside the platform, or may be displayed in the chat area 120 which is described later.

Referring to FIG. 9, as an additional embodiment, the area 721 or 723, where each comment information is displayed in the comment area 720, may include a status check area 725 indicating a ‘in progress’ which means that the producer performs updating of the content in response to the comment information, or a ‘completed status’ which means that the producer completes the updating. Specifically, when the comment information is first input, it may be blank to mean ‘in progress’. After that, the producer may confirm the comment, perform the updating with reflecting this, and then click the status check area 725 to change to the ‘completed status’.

Furthermore, as an additional embodiment, the server 10 may collect the status information of the status check area 725 in project unit. For example, after collecting and classifying the status information of ‘in progress’ and ‘completed status’ for all uploaded visual contents in the project, it is possible to grasp each number information in real time. By displaying the counted number information in one area of the project interface 300, it is possible for the producer to efficiently plan the task schedule.

Referring back to FIG. 7, the review interface 700 according to an embodiment of the present disclosure may include a subversion selection area 730, a version management menu 740, and a comparison menu 750.

As described above, during the production process, one visual content may be updated or changed to a main version having a plurality of precedence relationships and a subversion having a parallel relationship within the same main version. According to an embodiment of the present disclosure, in a case where a plurality of subversions for the same main version are uploaded, the server 10 may manage and provide the comment area 720 in main version unit.

For example, in a case where the visual content of ‘V.1C’ (the third subversion in the first main version) is displayed in the visual content display area 710, that is, when the reviewer terminal 30 performs the review function of ‘V.1C’, it is possible to request a desired visual content of another subversion through the subversion selection area 730. The subversion selection area 730 may be configured by listing items of subversions having a parallel relationship with ‘V.1C’, and when ‘V.1B’ (second subversion) is selected, the server 10 displays the visual content corresponding thereto in the visual content display area 710. At this time, the comment area 720 may maintain the displayed state of the comment information rather than being initialized even if another subversion is displayed.

In addition, in a case where the reviewer terminal 30 inputs the comment information through the annotation area 711 for ‘V.1B’, the server may display it in the comment area 720 and match it with the still image or the still frame of ‘V.1B’. After that, during confirming the comment area 720 in a state where ‘V.1C’, which is being reviewed, is displayed, in a case where the producer grasps the comment information on ‘V.1B’ left by the reviewer and clicks it, the server 10 may switch the ‘V.1C’ into the still image or the still frame of ‘V.1B’ matched with the comment information to display the comment information in the visual content display area 710.

As described above, the comment information collected in one comment area 720 may mean comment information input in a state where each subversion is displayed. That is, the collected comment information may be matched with the identification information of the visual content corresponding to the main version and stored. Accordingly, the comment area 720 may be generated in main version unit, and in a case where the first terminal 20 or the second terminal 30 is provided with the comment area 720, the comment information for respective subversions may be output in the order in which they are input.

On the other hand, according to an embodiment of the present disclosure, in a state where the review interface 700 is provided, in a case where a review of another main version is required, the review may be provided by clicking the version management menu 740 configured in one area of the review interface 700. In this case, as described above, the version tree area 600 may be provided, and in a case where click-inputting another main version or at least one subversion of the main version in the version tree, the server 10 may output the visual content of the clicked version, and switch into the comment area 720 matched therewith. For example, while performing the review function of ‘V.3A’ (the first subversion in the third main version), in a case where click ‘V.2C’ (the third subversion in the second main version) is clicked through the version tree area 600, the server 10 may switch and output ‘V.2C’ to the visual content display area 710, and provide the comment area 720 matched with the identification information of ‘V2’ (the second main version).

As described above, in the case of the production of complex or large-scale visual content, numerous updates and corrections may be made. Accordingly, an embodiment of the present disclosure proposes a method for managing comments individually or managing them by being limited them in main version unit in order to prevent a possibility that the comments generated during the production process are omitted. In addition, in a case where a review is desired for another main version, by including the version management menu 740 in the review interface, it is possible to supplement the limited management of comments and provide convenience.

According to an embodiment of the present disclosure, each member, particularly a reviewer, may compare visual contents corresponding to different menus at a glance through the comparison menu 750 in the review interface 700. First, in a state where the review interface for the first visual content, which is one of the all versions, is provided to the reviewer terminal 30, in a case where the reviewer terminal 30 clicks the comparison menu 750, the version tree area 600 may be provided. Thereafter, when the server 10 receives a selection input for one of the versions displayed in the version tree area 600, the second visual content corresponding to the version may be provided together.

For example, while performing the review function of ‘V.1C’, in a case of where it is desired to compare it with another draft ‘V.1D’ having a predetermined difference, the reviewer may request the comparison function which is described above. The server 10 may receive the request, divide the visual content display area 710 into two, and display the existing ‘V.1C’ in one area and ‘V.1D’ in the other area. For example, by displaying close by side by side, it may induce a smooth comparison by the reviewer.

Here, in a case where the first and second visual contents are the moving images, the two-divided visual content display area 710 may provide a function of simultaneously playing back and pausing respective visual contents. That is, by playing back and pausing together, the reviewer may compare changes or flows of the overall states, or intensively compare the still frames of a moment.

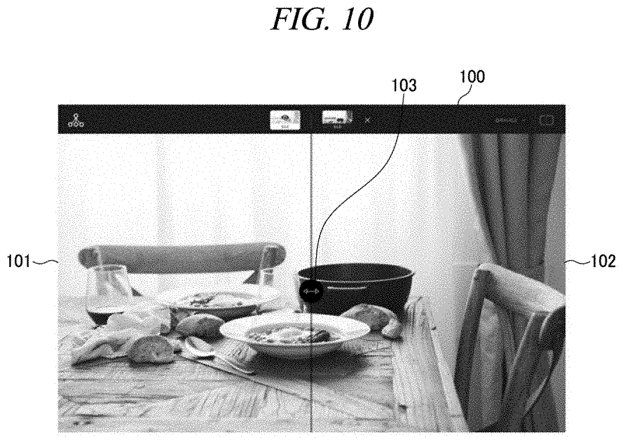

In addition, in a case where the first and second visual contents are still images, they may be displayed adjacently, or may be displayed overlappingly as illustrated in FIG. 10.

FIG. 10 is an exemplary view for explaining the comparison function in the review interface according to an embodiment of the present disclosure.

Referring to FIG. 10, the comparison function of the still images displayed overlappingly will be described as an example. As illustrated in the drawing, a predetermined dividing line 103 may be configured in a middle of the two-divided visual content display area 100, and based on this, the existing ‘V.1C’ may be displayed in the left area 101 and ‘V.1D’, which is a comparison target, may be displayed in the right area 102 as a higher order. That is, only ‘V.1C’ may appear in the left area 101 and ‘V.1D’ may be hidden. Alternatively, ‘V.1C’ may be displayed clearly, while ‘V.1D’ may be displayed only with a sharpness of a preset default value.

Thereafter, the terminal performing the comparison function may perform a movement input function of moving the dividing line 103 in a desired direction. The movement input function may mean a function of performing a drag input in at least one of a left-right direction, an up-down direction, and a direction of one area of a quadrant. Based on the movement input, the server 10 may expand an upper area of one of the first and second visual contents, and display the other one in the area as a lower area in response to the expanded area. For example, if the dividing line 103 is moved to the right, in ‘V.1C’, the portion displayed as lower is displayed as upper, and in ‘V.1D’, and the portion displayed as upper is displayed as lower as much as it is moved. Accordingly, the reviewer may precisely compare and analyze the form, shape, color, brightness, saturation and sharpness of the corresponding portion by repeatedly moving the dividing line 103 for the portion to be compared.

In an additional embodiment, the server 10 compares the image data between the first visual content and the second visual content for each preset corresponding range. In a case where a range determined to be greater than or equal to the preset difference is identified, the image processing process which is preset in this range is performed, and then the visual content display area 710 may be provided. For example, the comparison is performed in pixel unit, and in a case where it is determined that the number of pixels determined to be different between the both contents is greater than or equal to the preset number among the pixels included in the corresponding preset range, image processing process to highlight the range may be performed. Here, the image processing process does not limit a configuration thereof, such as increasing the size of the range, increasing the saturation or sharpness, or displaying a predetermined additional image.

As an additional embodiment, the server 10 may synthesize images between the both contents in an area in which the upper and lower display of the first and second visual contents is changed according to the movement of the dividing line 103. For example, a reference range for the difference value may be set in advance for each form, shape, color, brightness, saturation, and sharpness of the area. The server 10 compares the images of the area, and in a case where it is determined that the difference is very clear because it is not included in this reference range or it is difficult to compare the difference with the naked eye, the image of both contents of the area may be synthesized and displayed. Alternatively, the synthesis process may be performed according to the request of the terminal performing the comparison function. Accordingly, the reviewer may perform the comparison of both visual contents more efficiently.

As an additional embodiment, in the embodiment described above, only comparison of two visual contents is performed, but at least two or more versions may be selected and input through the comparison tree area 600 to compare at least three or more visual contents. In this case, the server 10 may equally divide the visual content display area 710 based on the number of selected and input versions, and display and provide the visual content of each version in each area. In addition, based on the number of divided areas, at least two dividing lines 103 may be configured in portions equally dividing areas.

As an additional embodiment, in the process of performing the comparison function, the above-described review function may also be performed on the visual contents to be compared. For example, while performing the review function of ‘V.1’, comparison with ‘V.2’, that is, the comparison function between main versions may be performed. In this case, through the annotation area 711 for ‘V.2’, the reviewer may overlap the drawing image 712 on a specific portion of ‘V.2’ and input the comment information. In this case, the input comment information may be collected in the comment area matched with the identification information of ‘V.2’. In this way, since the review function may be performed directly in the process of performing the comparison function between main versions, it is possible to solve the inconvenience of having to separately go through the version management menu 740.

On the other hand, in view of the object and effect of the present disclosure, it is necessary to limit the number of personnel directly involved in the project by receiving the main interface 400 and the review interface 700 corresponding to the project members. For example, there are cases where a project manager invites several creators to collaborate or outsources the management to create visual content. In this case, when the requesting client becomes a user of the second terminal 30, there is a high possibility that various types of information that should be kept private are leaked to the outside, and thus, problems of a reliability and productivity decrease may occur. Alternatively, in a case where the project is long-term or large-scale, the number of related personnel may continuously increase. However, even when only involved in a specific stage, if the authority of the project member is given, the generated intermediate data (visual content, comment information, or the like) increases too much, so there is a risk that the efficiency of review or management will be drastically reduced.

In order to prevent this problem, according to an embodiment of the present disclosure, basically, only the user of the second terminal 30 invited by the first terminal 20 sets a personnel limit that may directly participate in the project, and according to a situation, by providing a shared link function that allows the addition of the necessary manpower, a method for compensating for the personnel limitation is suggested.

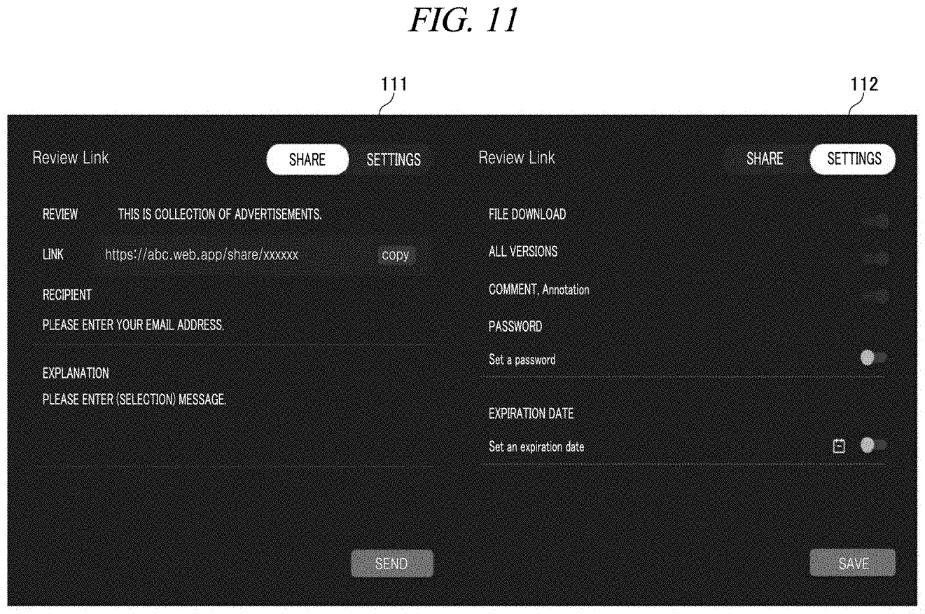

Hereinafter, a method for providing the shared link according to an embodiment of the present disclosure will be described with reference to FIG. 11.

FIG. 11 is an exemplary view for explaining the shared link function according to an embodiment of the present disclosure.

According to an embodiment of the present disclosure, the first terminal 20 or the second terminal 30 may click-input for the share link transmission menu in the main interface 400, and the server 10 may receive it, and provide the shared link access information input area 111 and the authority setting area 112.

Here, the shared link access information may include identification information of the visual content to be shared, identification information of the third terminal such as an e-mail address, and predetermined text message information explaining the content of the sharing request or the summary content of the visual content.

Thereafter, the server 10 may generate the shared link in which the visual content is displayed based on the input shared link access information, and provide the access information of the shared link to the third terminal.

The third terminal may access the server 10 through the shared link and input the user identification information corresponding to the third terminal. For example, the user identification information may be about bibliographical matters such as a name, a resident registration number, and address, and contact information, but is not limited to this.

The server 10 may receive the user identification information and grasp whether the third terminal is a previously registered terminal. Thereafter, a preset shared interface may be provided to the third terminal according to whether registration is performed.

On the other hand, in a case where the first terminal 20 or the second terminal 30 sets and inputs the conditions of the password and the share expiration date through the authority setting area 112, the third terminal may access the server 10 only in a case where such conditions are satisfied. For example, the visual content production is specialized, and if know-how or production process is exposed, it causes great damage. Therefore, in order to prevent this, more safety may be ensured by notifying a third party participating in the middle of the password in advance and confirming it.

In addition, the authority setting area 112 may include at least one of check areas for a download authority of shared visual content, an all-version access authority, and a usage authority of the review interface 700, and a configuration thereof does not limit the present disclosure.

A first embodiment of the method for providing the shared link of the present disclosure is a case where the server 10 determines that the third terminal is the previously registered terminal according to the user identification information input by the third terminal. In this case, the user of the third terminal is a member of the platform provided by the server 10 and may be a user who is granted an account and a predetermined authority for using the service at the time of membership registration. Accordingly, the shared interface provided by the third terminal may mean the main interface 400.

However, it may be dangerous to grant the authority to directly participate in all processes related to the project just by providing a shared link. For example, as described above, if the personnel is a client or an employee of an external company temporarily involved in an intermediate stage, it may be difficult if the internal information is leaked to the outside by the personnel.

Accordingly, in a case where it is determined that the third terminal is in the previously registered state, the server 10 may additionally determine whether it is a terminal corresponding to the project member. Accordingly, in a case where it is determined as the project member, the same main interface 400 used by the first terminal 20 and the second terminal 30 may be provided. For example, in a case where the personnel belongs to project members, but is only involved in the production of the shared visual content, the personnel may conveniently recognize his/her task status by receiving the shared link.

On the other hand, if the personnel is not a project member, even a user who is a member may be provided with the main interface 400 with limited functions. For example, only the authority checked from the first terminal 20 or the second terminal 30 through the authority setting area may be granted to the personnel.

A second embodiment of the method for providing the shared link of the present disclosure is a case where it is determined that the third terminal is an unregistered terminal and the download authority in the authority setting area is checked. In this case, the third terminal may view the displayed visual content after accessing the server 10 through the shared link, and after downloading through the download link generated and provided by the server 10, it may be confirmed in an offline state

A third embodiment of the method for providing the shared link of the present disclosure is a case where it is determined that the third terminal is an unregistered terminal and the all versions access authority is checked. In this case, the shared interface may include the version tree area, which may not be connected to the review interface 700, unlike the version tree provided through the version management menus 401 and 740, and the comparison menu 750 which are described above. Accordingly, the third terminal may select and input one of the versions displayed in the version tree area and receive the visual content accordingly.

As an additional embodiment of the third embodiment, in a case where both the all versions access authority and the review interface usage authority are checked, the version tree area included in the shared interface may be connected to the review interface 700.

Accordingly, when the third terminal selects and inputs one of the version trees, the review interface 700, in which the visual content of the selected version is displayed, is provided, and the review function and the comparison function may be performed.

A fourth embodiment of the method for providing the shared link of the present disclosure is a case where it is determined that the third terminal is an unregistered terminal and the review interface usage authority is checked. In this case, the shared interface provided by the server 10 may mean the review interface 700 including the visual content display area 710 in which the visual content to be shared is displayed, the annotation area 711, and the comment area 720. Accordingly, the third terminal may input the comment information and the drawing image 712 through the annotation area 711 and the comment area 720, and the server 10 may collect it and match it with the shared visual content identification information (in a case of the subversion, the identification information of the main version thereof) to store it. After that, in a case where the first terminal 20 or the second terminal 30 performs the click-input on one of the comment information input by the third terminal on the review interface 700 of the shared visual content, the server 10 may display the still image or the still frame matched thereto on the visual content display area 710. Specific details related thereto will be substituted for the above description. Accordingly, the project members may quickly identify which part the comment of the user who requests the share is.

The fifth embodiment of the method for providing the shared link of the present disclosure is an additional embodiment of the fourth embodiment, in which the comment information input by the third terminal may include a preset sharer identification mark so as to be distinguished from the comment information input from the terminals 20 and 30 of the project members. For example, a lot of comment information is collected in the comment area 720 due to active review, and may be continuously added in real time. In this case, it may not be easy to find the comment of the sharer. The fifth embodiment discloses a configuration of a sharer identification display for visually recognizing the comment information input by the sharer in order to prevent such a problem.

A sixth embodiment of the method for providing the shared link of the present disclosure is an additional embodiment of the fourth embodiment. This is a case where the still image or the still frame, in which the drawing image input by the third terminal through the annotation area is displayed, includes another drawing image input by a project member. As described above, the server 10 performs a predetermined image processing process on the visual content display area 710 so that the drawing image is highlighted. In the case of the sixth embodiment, a separate image processing process may be additionally performed so that respective drawing images are distinguished. For example, the additional image processing process may be performed to differentiate respective drawing images by differentiating a color, a sharpness, a thickness, a line type thereof, and the like, or to include the sharer identification display to the drawing image by the third terminal. Of course, such a configuration is not limited to the example.

Accordingly, in a case where the user of the first terminal 20 is the creator, the user of the second terminal 30 is the project manager, and they transmit the shared link according to the sixth embodiment to the client who is the user of the third terminal, the creator may visually distinguish between the project manager's opinion and the client's opinion within the same image or frame, and ensure objectivity.

On the other hand, the server 10 may collect the shared link record information for each visual content uploaded in the project and provide it according to the request of the project member terminal. For example, the shared link record information may include at least one of the number of times of access to the shared link, the timing, the set authority thereof, and the shared interface performance history information for each third terminal, but is not limited to this. Therefore, each project member may systematically manage the personnel expansion generated at each stage during the project process.

On the other hand, according to an embodiment of the present disclosure, as described in the review function, the comment information may be processed in main version unit in order to efficiently transmit and reflect the comment. In addition, for the systematic management of the project, a function, which is processed in visual content unit (including the previous version), such as the upload area 502 and the version management menu 401, is provided. An embodiment of the present disclosure discloses a chat function capable of communicating over an entire range of the project in order to supplement the limitation of such a management unit.

Hereinafter, a method for providing a chat function according to an embodiment of the present disclosure will be described. A common detailed description will be replaced with the above-mentioned description.

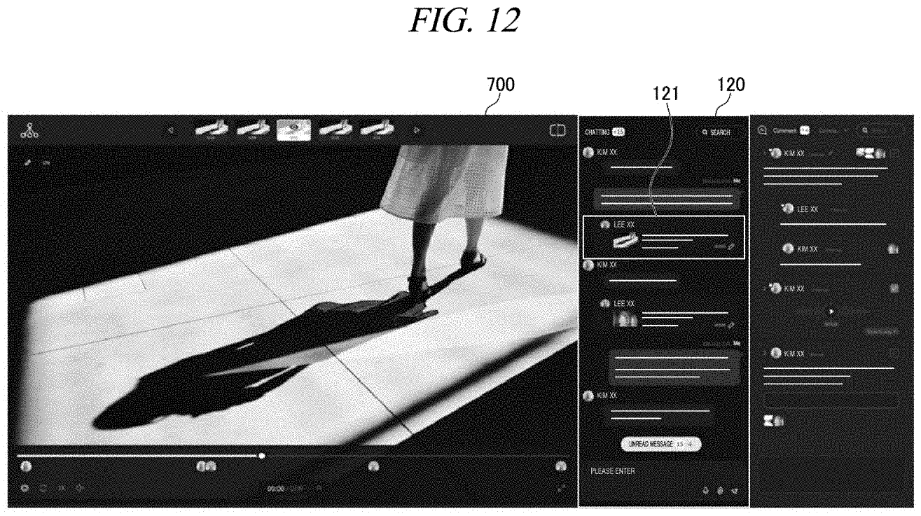

FIG. 12 is an exemplary view for explaining the chat function according to an embodiment of the present disclosure.

In a case where the server 10 receives an input for the chat menu in the main interface 400 or the review interface 700 from the first terminal 20 or the second terminal 30, the chat area 120 may be provided. Through the chat area 120, respective project members may freely share text and voice comments on the project.

Referring to FIG. 12, in a case where the chat menu is input in a state where the review interface 700 is provided, the server 10 may reduce at least one of the visual content display area 710 and the comment area 720, and configure the chat area 120 in the reduced area to provide it to each terminal. In addition, even if the chat area 120 is provided, it does not mean that the comment area 720 is not included, but respective areas may be provided at the same time.

According to an embodiment of the present disclosure, the review function and the chat function may operate organically. Specifically, the comment information input by the project member to the terminal thereof through the comment area 720 may be matched with the visual content identification information, and may be stored in the database corresponding to the chat area of the project in the server 10. Therefore, in a case where the chat area 120 and the comment area 720 are provided at the same time, the comment information may be displayed at the same time in both areas in real time.

In addition, the comment information input through the annotation area 711 and the identification icon matched with the drawing image 712 may be stored in the database corresponding to the chat area of the project while being displayed in the comment area. Accordingly, in a case where the chat area 120 is simultaneously provided, the area 121 in which the comment information through the annotation area and the identification icon matched with the drawing image 712 are displayed may be configured and provided.

After that, when the first terminal 20 or the second terminal 30 clicks the chat menu on the main interface 400, the chat information and the comment information collected in the database corresponding to the chat area may be sequentially displayed in the chat area 120 based on the collected time. After that, in a case where one of the comment information such as the area 121 is click-input, the server 10 may extract the visual content matched with the click-input comment information and provide the review interface 700 therefor. That is, in a case where the producer grasps the comment information input in advance by the reviewer and clicks on it while chatting with the reviewer in state of the main interface 400, it may be switched to the state of the review interface 700 matched with the comment information, and quickly reflect the feedback of the reviewer to the visual content.

According to an embodiment of the present disclosure, unlike the comment area 720, the chat area 120 is not managed in main version unit, but is managed for each project in view of the purpose of the present disclosure. Accordingly, in a state where all main versions as well as subversions are displayed, the comment information and drawing images collected in the chat area may be matched with the identification information of the project. Therefore, regardless of the version, the comment information may be sequentially displayed in the chat area 702 based on the collected time.

In addition, in the area where each comment information in the chat area 120 is displayed, the version information corresponding thereto may be added and displayed. Accordingly, the project members may visually identify which version of the visual content the corresponding comment information is about.

In this regard, in a case of performing the chat function in a state where at least one review interface 700 is provided among all versions including the main and subversions, the project members may click-input one of reviews in the comment information configured in the chat area 120. Thereafter, the visual content of the version matched with the click-input comment information may be extracted, and the review interface 700 in a state of including the same may be provided to the terminal of the project member.

For example, in a case where the producer confirms the chat while performing the review function for ‘V.1A’ and urgently needs to work on the comment input for ‘V.2A’, the producer may click the comment. In this case, unlike the comment area 502, despite the switching of the main version, the server 10 may display ‘V.2A’ in the visual content display area 710 and provide the comment area matched with the second main version. At this time, the visual content display area 710 may be divided and displayed together with ‘V.1A’, or only ‘V.2A’ may be configured and displayed. Similarly, only the comment area matched with the second main version or together with the comment area matched with the first main version may be configured in the review interface 700.

Furthermore, since the chat area 120 according to an embodiment of the present disclosure is managed for each project, the comment information and the drawing images collected for all visual contents included in all upload areas 502 in the project may be sequentially displayed in the chat area 120 based on the collected time. In this case, the identification information of the visual content may be configured and displayed in the area where each comment information is displayed.

On the other hand, the project members may input the chat information and upload files through the chat area 120. That is, various types of additional information related to the project process may be shared in real time while transmitting and receiving the text or voice. The file upload function may be capable of uploading at least one of a text file, a voice file, a still image file, and a moving image file, but is not limited to this configuration.

According to an embodiment of the present disclosure, in relation to the chat function, the server 10 may track traffic information for the main interface 400 and the review interface 700 for each terminal of the project member. Specifically, the activity history of each terminal for the reference data menu, the shared link transmission menu, the file transmission menu, the version management menu, and the visual content upload in the main interface, and the activity history through the annotation area and the comment area in the review interface may be tracked and detected.

Thereafter, a preset input signal transmitted from each terminal may be detected based on the tracking. Specifically, the preset input signal may include at least one of the input signals for the reference data menu, the shared link transmission menu, the file transmission menu, the version management menu, and the visual content upload in the main interface, and the input signals through the annotation area and the comment area in the review interface.

The server 10 may provide a preset notification signal according to the detected input signal to terminals of other project members other than the terminal that transmitted the input signal. For example, in a case where the first terminal 20 uploads a new visual content, an upload signal may be detected, and a notification message informing of this fact may be displayed in the chat area 120. Alternatively, a predetermined pop-up window including the notification signal may be provided or a voice signal may be transmitted, and another message system outside the platform may be used. Of course, the configuration of such a notification signal does not limit the present disclosure.

As described above, the chat function according to an embodiment of the present disclosure may provide the effect of quantitative expansion on project progress efficiency. That is, in order to systematically manage and quickly identify a large number of data generated during the progress of the project, and prevent the risk of omission thereof, the comment information may be managed individually or in main version unit, and the visual content may be managed in upload area 502 unit. On the other hand, since the chat area 120 is managed in project unit, it may act as an effective complement to the interface in which such quantitative restrictions are set. Accordingly, convenience may be further increased.

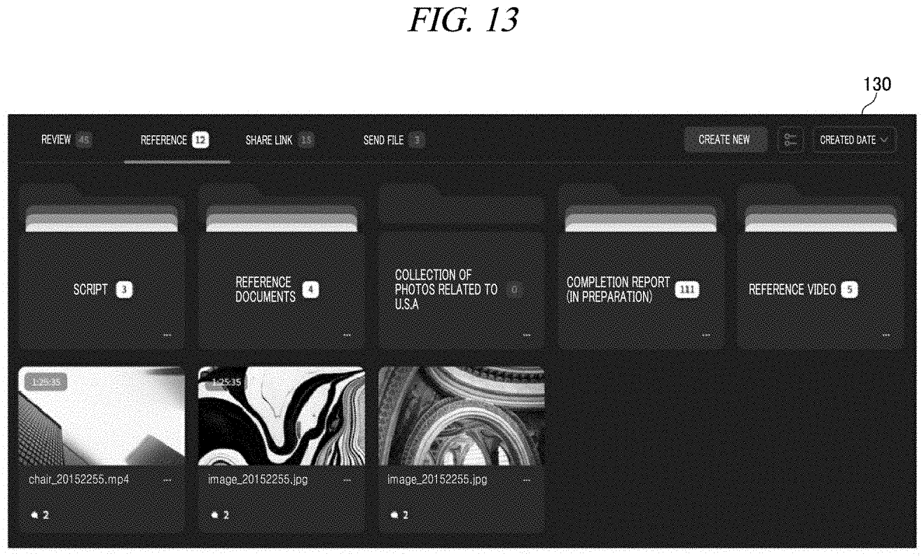

Referring back to FIG. 4, according to an embodiment of the present disclosure, the first terminal 20 or the second terminal 30 may click-input the reference menu in the main interface 400. In this case, referring to FIG. 13, the server 10 may provide the upload area 130 of the reference data related to the project, and the reference data may include at least one of the still image, the moving image, the design source image, and the text data. As described above, the project members may easily share and manage the reference data related to the project without using a separate communication system.

In addition, according to an embodiment of the present disclosure, in a case where the reference data is image data, the project member may review the image data. For example, in a case where it is uploaded as the reference content but it is determined as image data that has a significant influence on the project, the first terminal 20 or the second terminal 30 may transmit an input for a review request that regards it as the visual content to the server 10. The server 10 may receive the input, allocate the upload area 502 for the image data, and then provide the review interface 700 displaying it to the first terminal 20 or the second terminal 30.

On the other hand, according to an embodiment of the present disclosure, the first terminal 20 or the second terminal 30 may request that specific visual content be transmitted to another terminal by click-inputting the file transmission menu in the main interface 400. Specifically, the server 10 may provide a file transmission information input area including a function of listing and displaying items of the uploaded visual content in the project, and selecting and inputting at least one of them. Here, the file transmission information may include download link access information, identification information of the transmission target terminal, password information, or download deadline information, but is not limited to this.

The server 10 may generate a download link capable of downloading the selected visual content based on the input information, and transmit the download link access information to the transmission target terminal. Accordingly, in a case where the download is completed through the download link, the server 10 may collect the download record information. Here, the download record information may include at least one of the number of downloads for each visual content, the timing thereof, and identification information of the terminal that performed the download, but is not limited to this.

After that, the project member may view such download record information. Accordingly, it is possible to confirm whether the download is performed exactly as scheduled, to confirm a situation in which the download is unintentionally leaked to the outside, and to strengthen security.

An embodiment of the present disclosure may also be implemented in a form of a recording medium including instructions executable by a computer, such as a program module executed by a computer. The computer-readable medium may be any available medium that is accessed by a computer and includes both volatile and nonvolatile media, removable and non-removable media. In addition, the computer-readable medium may include all computer storage media. The computer storage medium includes all volatile and nonvolatile, removable and non-removable media implemented in any method or technology for storage of information such as computer readable instructions, data structures, program modules or other data.

Although the methods and systems of the present disclosure have been described with reference to specific embodiments, some or all of their components or operations may be implemented by using a computer system having a general purpose hardware architecture.

The description of the present disclosure described above is for illustration, and those of ordinary skill in the art to which the present disclosure pertains may understand that the embodiments may be easily modified into other specific forms without changing the technical spirit or essential features of the present disclosure. Therefore, it should be understood that the embodiments described above are illustrative in all respects and not restrictive. For example, each component described as a single type may be implemented in a dispersed type, and likewise components described as the distributed type may be implemented in a combined type.

The scope of the present disclosure is indicated by the following claims rather than the above detailed description, and all changes or modifications derived from the meaning and scope of the claims and their equivalents should be interpreted as being included in the scope of the present disclosure.

What is claimed is:

1. A method for providing a function to review visual contents by a server, the method comprising:
(a) providing a visual content upload area to a first terminal and receiving an upload request including identification information of previously produced visual content from the first terminal;
(b) receiving a click-input for the visual content of the first terminal or a second terminal invited by the first terminal and providing a review interface to the first terminal or the second terminal; and
(c) collecting comment information input by the first terminal or the second terminal through the review interface and storing the comment information by matching with the identification information of the visual content,
wherein the first terminal and the second terminal respectively mean a visual content producer terminal and a reviewer terminal,
wherein the visual content includes a still image or a moving image, and the moving image is configured of a set of a plurality of still frames formed in a preset order, and
wherein the review interface includes a visual content display area, an annotation area and a comment area including a function of visually displaying a portion to be reviewed and evaluated in the visual content display area.

2. The method for providing a function to review visual contents of claim 1, wherein in the step (b),
when the visual content is a still image, the visual content display area provides a function of enlarging or reducing the still image, and
when the visual content is a moving image, the visual content display area sequentially displays each still frame based on a playback mode selected and input by the first terminal or the second terminal, and
wherein the playback mode include at least one of for hour-minute-second, for frame, and for hour-minute-second vs frame per second.

3. The method for providing a function to review visual contents of claim 1,
wherein the comment area provides a function of inputting comment information related to the visual content, and the comment information includes text information and voice information, and
wherein in a state where a specific still image or still frame is displayed in the visual content display area, the comment information input by the second terminal is displayed in the comment area, and is stored by matching with the still image or the still frame.

4. The method for providing a function to review visual contents of claim 3, wherein the step (b) includes,
displaying a still image or a still frame matched with click-input comment information in the visual content display area when the first terminal performs a click-input on one of the comment information displayed in the comment area.

5. The method for providing a function to review visual contents of claim 3,
wherein when the visual content is a moving image, a predetermined comment icon corresponding to the still frame matched with the comment information is generated and matches with the still frame,
wherein the comment icon is displayed in a portion corresponding to the still frame matched with the comment icon in a still frame selection function area included in the visual content display area, and
wherein when the first terminal or the second terminal performs a click-input on the comment icon, the still frame is displayed in the visual content display area and comment information matched with the still frame is displayed in the comment area.

6. The method for providing a function to review visual contents of claim 1, wherein in the step (b),
the annotation area provides a drawing input function and a comment input function, and
wherein the step (b) includes,
generating a drawing image based on a drawing input and displaying the drawing image by overlapping in a still image or a still frame displayed in the visual content display area when the second terminal selects and inputs a drawing tool and color and performs the drawing input function; and
matching and storing the drawing image and a predetermined identification icon.

7. The method for providing a function to review visual contents of claim 6,
wherein the comment input function provided by the annotation area includes a text and voice input function,
wherein when the second terminal inputs comment information related to the drawing image through the comment input function, the input comment information is displayed in the comment area in the review interface and matched with the still image or the still frame, and stored, and
wherein the identification icon matched with the drawing image is further displayed in an area in which the comment information is displayed.

8. The method for providing a function to review visual contents of claim 7,
wherein when the first terminal performs a click-input on the comment information related to the drawing image, a still image or a still frame matched with the comment information, and a drawing image matched with the identification icon are displayed in the visual content display area, and
wherein a preset image processing process is performed and displayed so that the drawing image is highlighted.

9. The method for providing a function to review visual contents of claim 1, wherein in the step (c),
a visual content which is initially uploaded is set as a first main version and stored,
when an additional visual content is uploaded to the upload area, the additional visual content is set and stored as a next main version having a precedence relationship based on a version check input of the first terminal or the second terminal, or a subversion having a parallel relationship in the same main version, and
wherein the step (c) includes,
managing the comment area in main version unit by matching the collected comment information with identification information of the visual content corresponding to the main version having the parallel relationship with the subversion, and storing the collected comment information, when the comment information is collected in a state where the visual content corresponding to the subversion is displayed in the visual content display area.

10. The method for providing a function to review visual contents of claim 9, wherein after the step (b),
in a state where a review interface for a first visual content, which is one of all versions of the visual content, is provided to the first terminal or the second terminal, further comprising:
receiving an input for a comparison menu in the review interface from the first terminal or the second terminal, and providing a version tree area in which the all versions of the visual content is displayed;
receiving a selection input for a second visual content from the first terminal or the second terminal through the version tree area; and
dividing the visual content display area in the review interface into two and displaying the first visual content in one area and the second visual content in the other area.

11. The method for providing a function to review visual contents of claim 10,
wherein when the first and second visual contents are moving images, the visual content display area provides a function of simultaneously playing back and pausing the first and second visual contents,
wherein when the first and second visual contents are still images, the first and second visual contents are displayed overlapping each other, and a dividing line is formed in the middle of the visual content display area, the first visual content is displayed as upper in one area based on the dividing line, and the second visual content is displayed as upper in the other area based on the dividing line, and
wherein an area, in which one of the first and second visual contents is displayed as upper, is expanded, and the other is displayed as lower corresponding to the expanded area based on a movement input of the dividing line.

12. A device for providing a function to review visual contents, the device comprising:
a memory in which a program for performing a method for providing a function to review visual contents is stored; and
a processor for executing the program,
wherein the processor, by executing the program,
provides a visual content upload area to a first terminal and receives an upload request including identification information of previously produced visual content from the first terminal;
receives a click-input for the visual content of the first terminal or a second terminal invited by the first terminal and provides a review interface to the first terminal or the second terminal; and
collects comment information input by the first terminal or the second terminal through the review interface and stores the comment information by matching with the identification information of the visual content,
wherein the first terminal and the second terminal respectively mean a visual content producer terminal and a reviewer terminal,
wherein the visual content includes a still image or a moving image, and the moving image is configured of a set of a plurality of still frames formed in a preset order, and
wherein the review interface includes a visual content display area, an annotation area and a comment area including a function of visually displaying a portion to be reviewed and evaluated in the visual content display area.
